(19) United States
(12) Patent Application Publication
(10) Pub. No.: US 2021/0255703 A1
(43) Pub. Date: Aug. 19, 2021

(54) METHODS AND SYSTEMS OF A HYBRID MOTION SENSING FRAMEWORK

(71) Applicants: PAUL SCHREINER, Copenhagen (DK); ANDERS KLOK SANDER, Valby (DK); MATIAS SØNDERGAARD, COPENHAGEN (DK); MAZIAR TAGHIYAR-ZAMANI, Odense (DK); JAKOB BALSLEV, San Francisco, CA (US)

(72) Inventors: PAUL SCHREINER, Copenhagen (DK); ANDERS KLOK SANDER, Valby (DK); MATIAS SØNDERGAARD, COPENHAGEN (DK); MAZIAR TAGHIYAR-ZAMANI, Odense (DK); JAKOB BALSLEV, San Francisco, CA (US)

(21) Appl. No.: 17/106,172

(22) Filed: Nov. 29, 2020

Related U.S. Application Data
(63) Continuation-in-part of application No. 16/911,377, filed on Jun. 24, 2020, now abandoned.
(60) Provisional application No. 62/865,956, filed on Jun. 24, 2019.

(51) Int. Cl. G06F 3/01; G06F 3/0346; G06T 11/00; G01P 15/18; G01C 19/00; G01D 5/20

(52) U.S. Cl. CPC G06F 3/014; G06F 3/0346; G01D 5/20; G01P 15/18; G01C 19/00; G06T 11/001

(57) ABSTRACT

In one aspect, a computerized process useful for managing a hybrid motion sensing framework includes the step of providing a motion capture framework worn by a user to measure a user posture and motion by measuring an external source signal and an inertial property of the motion capture framework. The motion capture framework comprises a set of motion sensing units (MSUs) and an electromagnetic field generator (EFG). The MSU is a hybrid sensing system using a combination of sensors to measure position and orientation. The EFG generates an alternating electromagnetic field with a specified frequency. The method includes the step of calculating the user posture and motion based on the measuring an external source signal and an inertial property of the motion capture framework using a sensor fusion algorithm. The method includes the step of visualizing the position and orientation of the user.

### CROSS-REFERENCE TO RELATED APPLICATIONS

This application claims priority to U.S. patent application Ser. No. 16/911,377, titled METHODS AND SYSTEMS OF A HYBRID MOTION SENSING FRAMEWORK and filed on 24 Jun. 2020. This application is hereby incorporated by reference in its entirety. U.S. patent application Ser. No. 16/911,377 claims priority to U.S. provisional patent application No. 62/865,956, titled METHODS AND SYSTEMS OF A HYBRID MOTION SENSING FRAMEWORK and filed on 24 Jun. 2019. This application is hereby incorporated by reference in its entirety.

### FIELD OF THE INVENTION

The invention is in the field of motion sensing and analysis and more specifically to a method, system, and apparatus of a hybrid motion sensing framework.

### DESCRIPTION OF THE RELATED ART

Problems can arise when classifying different body positions and movements using only data from sensors positioned on the body (e.g. no visual data). Accordingly, improvements to classifiers to distinguish between static positions and dynamic movements are desired.

### SUMMARY

In one aspect, a computerized process useful for managing a hybrid motion sensing framework includes the step of providing a motion capture framework worn by a user to measure a user posture and motion by measuring an external source signal and an inertial property of the motion capture framework. The motion capture framework comprises a set of motion sensing units (MSUs) and an electromagnetic field generator (EFG). The MSU is a hybrid sensing system using a combination of sensors to measure position and orientation. The EFG generates an alternating electromagnetic field with a specified frequency. The method includes the step of calculating the user posture and motion based on the measuring an external source signal and an inertial property of the motion capture framework using a sensor fusion algorithm. The method includes the step of visualizing the position and orientation of the user.

### BRIEF DESCRIPTION OF THE DRAWINGS

FIG. 1 illustrates an example hybrid motion sensing framework system, according to some embodiments.

FIG. 2 schematic overview of the three-part motion capture framework, according to some embodiments.

FIG. 3 illustrates an example schematic overview of the smart glove with both an internal and an external EFG, according to some embodiments.

FIG. 4 illustrates an example schematic overview of the smart glove with only an external EFG, according to some embodiments.

FIG. 5 illustrates an example schematic overview of the smart glove with only an internal EFG, according to some embodiments.

FIG. 6 illustrates an overview of a smart glove use case, according to some embodiments.

FIG. 7 provided an overview of a smart suit with smart glove(s) with an external reference EFG, according to some embodiments.

FIG. 8 provides an overview of a smart suit with smart glove(s) with internal EFGs, according to some embodiments.

FIG. 9 depicts an exemplary computing system 900 that can be configured to perform any one of the processes provided herein.

The Figures described above are a representative set and are not an exhaustive with respect to embodying the invention.

### DESCRIPTION

Disclosed are a system, method, and article of manufacture for a hybrid motion sensing framework. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Accelerometer is a device that measures acceleration such as proper acceleration. Proper acceleration is the acceleration (e.g. the rate of change of velocity) of a body in its own instantaneous rest frame.

Gyroscope is a device used for measuring or maintaining orientation and angular velocity.

Electromotive force/field (EMF) sensor measures the ambient (e.g. surrounding) electromagnetic field(s).

### Example Systems

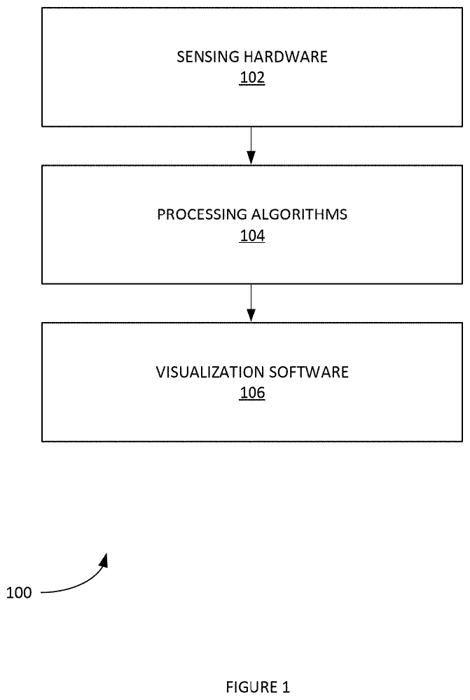

FIG. 1 illustrates an example hybrid motion sensing framework system 100, according to some embodiments. Hybrid motion sensing framework system 100 includes sensing hardware 102. Sensing hardware 102 measures human/user posture and motion. Sensing hardware 102 measure an external source signal, an inertial property(s), etc. The external reference signal is used to obtain a high accuracy position and orientation measurement. This can be with respect to a fixed reference point. When the user is out of range of the reference signal, Sensing hardware 102 can utilize inertial measurements for estimating the relative position and orientation. This can be with respect to the last known absolute position and orientation.

Process algorithms 104 calculate the position and orientation. Process algorithms 104 can include sensor fusion algorithms. Sensor fusion algorithms use information from any available sensor. Sensor fusion algorithms can then fuse this sensor information to obtain an optimal estimate of the position and orientation.

The position and orientation information is visualized (e.g. in real-time and/or by digital image processing) visualization software 106. Visualization software 106 applies the information about position and orientation of the sensor to a specified model. The model includes rigid and textured bodies to display an assembly of sensors. For example, the model can be a model of a human and each sensor position and orientation corresponds to position and orientation of a limb. In another example the model can be a human-hand model and the sensors provide the position and orientation of the hand and fingers.

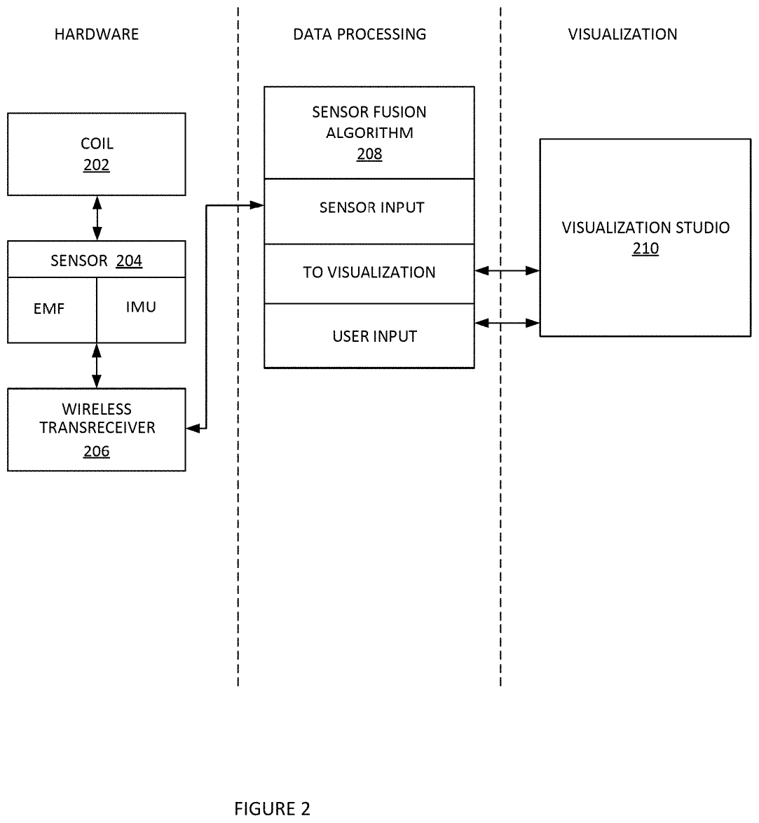

FIG. 2 schematic overview of the three-part motion capture framework 200, according to some embodiments. It is noted that framework 200 can be extended to multiple sensors and that a single sensor system is provided herein for purposes of simplicity.

The hardware aspect of framework 200 can include coil 202, sensor(s) 204 and wireless receiver 206. These can be used to implement motion sensing units (MSUs) and an electromagnetic field generator (EFG) which generates an alternating electromagnetic field with a specified frequency. The MSU is a hybrid sensing system using a combination of sensors to measure position and orientation. Sensor(s) 204 can include, inter alia: a 3-axis accelerometer; a 3-axis Gyroscope; a 3-axis electromotive force (EMF) sensor; a 3-axis magnetometer, etc. Accordingly, it is noted that different configurations of MSUs are possible. In one example, the hardware aspect of framework 200 can be a full body suit with MSUs on each limb. In another aspect, the hardware aspect of framework 200 can be implemented as a pair of gloves with MSUs on the hands and fingers. These examples are provided by way of example and not of limitation.

### Mocap Glove/Smart Glove

Here we describe a use case of a motion capture glove, with MSUs on the fingers and hand, an external EFG and/or an internal EFG. The external EFG can, as an example, be placed on a desktop, a stand, or any other location. The internal EFG is mounted onto the glove, for example the back of the hand. Two smart glove modes of operation can be implemented individually and/or in combination, depending on the type of EFG used.

Smart glove modes of operation includes a global positioning mode. In global positioning mode an external three-axis EFG generates an electromagnetic (EMF) field. The EMF field produces a voltage over the coil(s) (e.g. coil(s) 202) in each axis of the EMF-sensor. This voltage is used to calculate the position and orientation with respect to the external EFG.

Smart glove modes of operation includes a local (finger only) positioning mode. In local positioning mode a three-axis EFG positioned on the back of the hand generates an EMF field. The EMF produces a voltage over the coils in each axis of the EMF-sensor. This voltage is used to calculate the position and orientation with respect to the internal EFG.

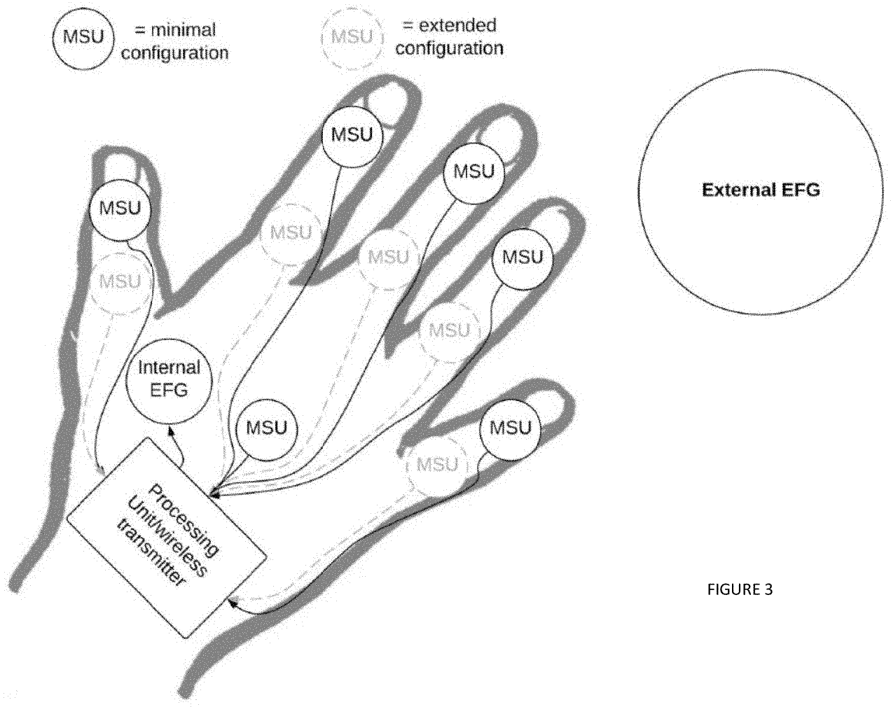

FIG. 3 illustrates an example schematic overview 300 of the smart glove with both an internal and an external EFG, according to some embodiments. FIG. 3 illustrates a minimal configuration of one sensor per finger and an example of an extended configuration (e.g. as dashed, transparent sensors). The hardware system of the smart glove can include an internal/external EFG. A sensor on the back of the hand is used to determine the global position and orientation of the hand. Sensors on each finger are used to determine a position and orientation of each finger. An external EFG is provided. An auxiliary EFG on the back of the hand is provide for use without global position and orientation (e.g. finger position and orientation only).

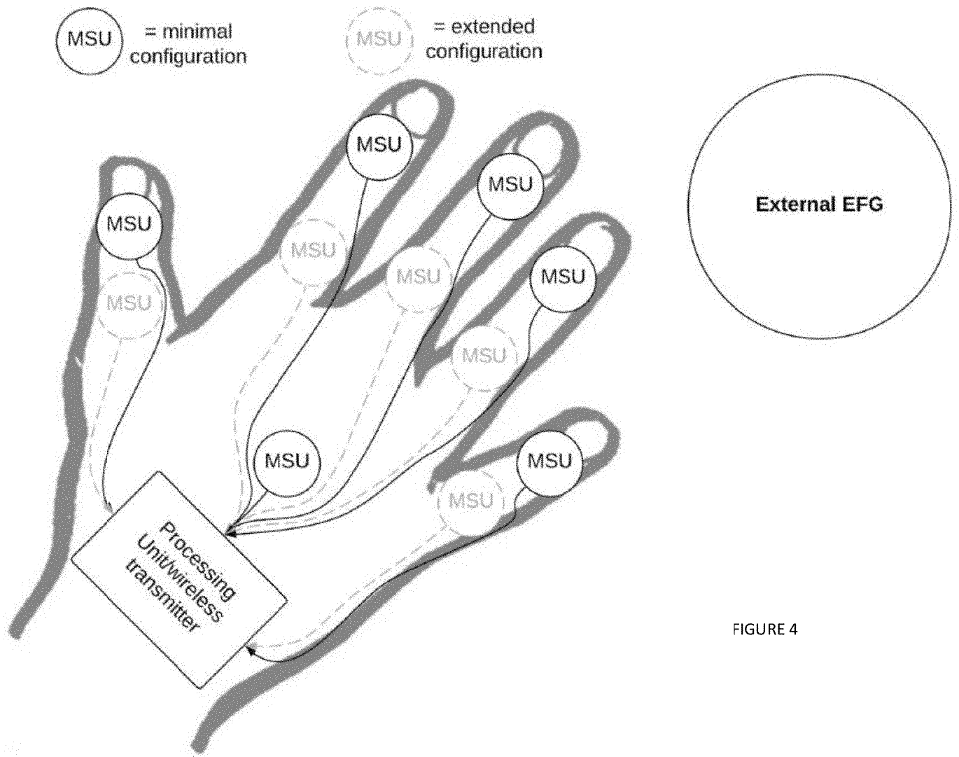

FIG. 4 illustrates an example schematic overview 400 of the smart glove with only an external EFG, according to some embodiments. FIG. 4 illustrates a minimal configuration of one sensor per finger and an example of an extended configuration (e.g. as dashed ,transparent sensors). The hardware system of the smart glove of can an external EFG. A sensor on the back of the hand is used to determine the global position and orientation of the hand. Sensors on each finger determine a position and orientation of each finger. An external EFG is provided.

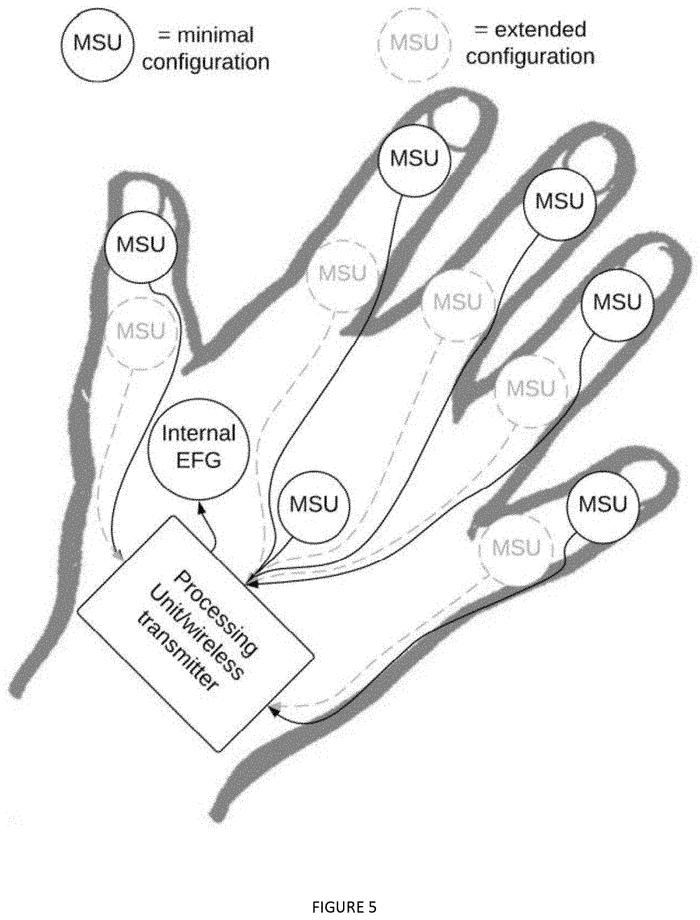

FIG. 5 illustrates an example schematic overview 500 of the smart glove with only an internal EFG, according to some embodiments. The figures illustrates a minimal configuration of one sensor per finger and an example of an extended configuration (e.g. dashed, transparent sensors).

The hardware system of the smart glove of can include an internal EFG. Sensors on each finger determine a position and orientation of each finger. An auxiliary EFG on the back of the hand is provided for use without global position and orientation (e.g. finger position and orientation only).

It is noted that, a smart glove include a wireless transmitter (e.g. wireless transceiver 206) to send sensor data and receive user input if needed.

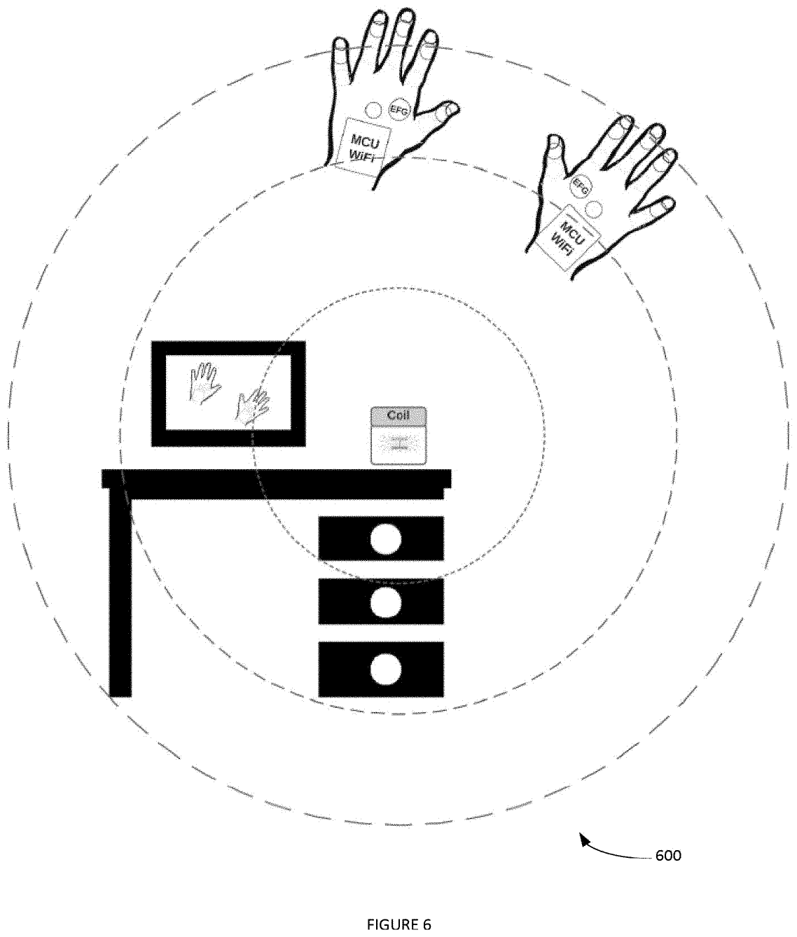

FIG. 6 illustrates an overview 600 of a smart glove use case, according to some embodiments. As shown, a desktop coil is used as external reference for two gloves. The signal is processed and the hand pose, position and orientation are visualized.

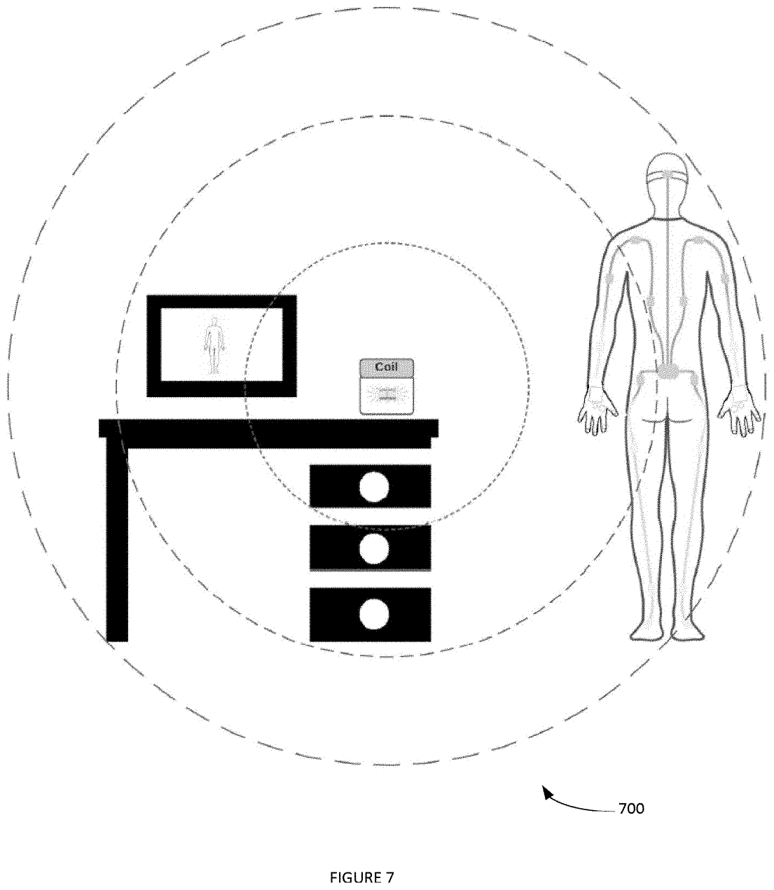

FIG. 7 provided an overview 700 of a smart suit with smart glove(s) with an external reference EFG, according to some embodiments. As shown, a full body and hand motion capture setup is provided. A desktop coil is used in combination with a suit and with MSUs.

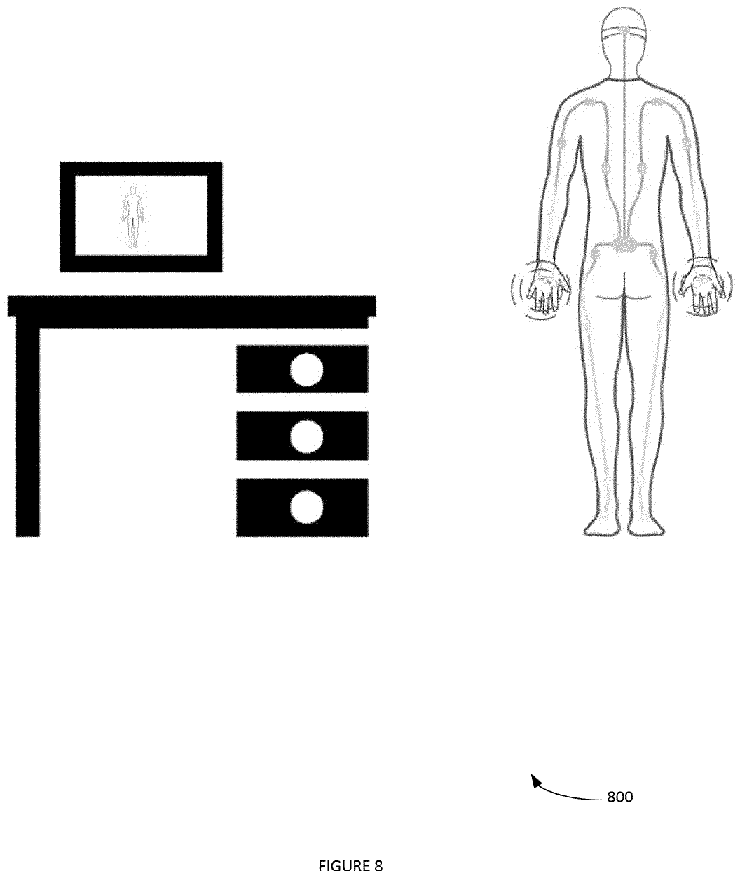

FIG. 8 provides an overview 800 of a smart suit with smart glove(s) with internal EFGs, according to some embodiments. Overview 800 provides a full body and hand motion capture setup. The smart suit is fully IMU based while the hand uses internal EFGs for accurate finger tracking.

### Additional Systems and Architecture

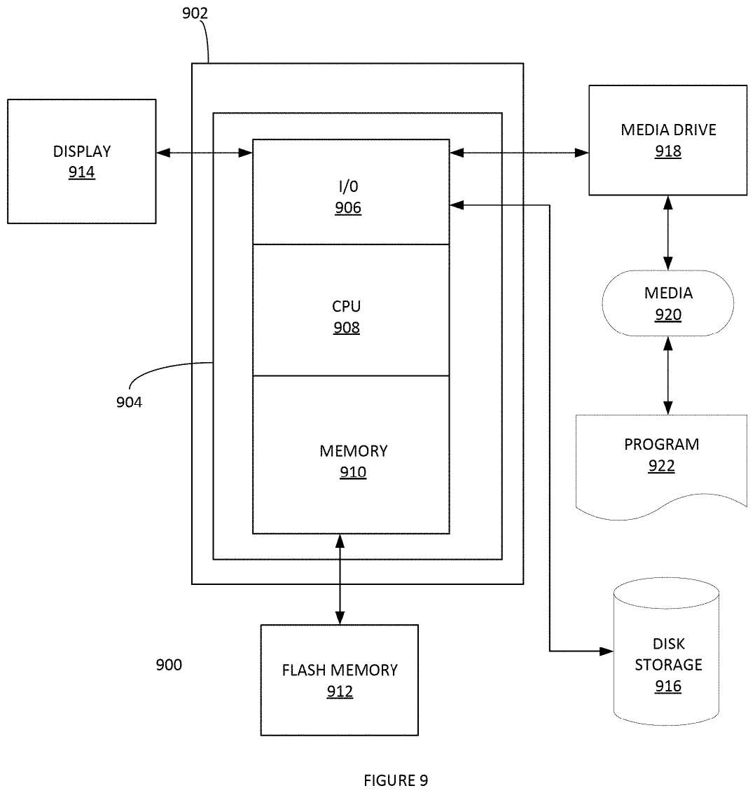

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized process useful for managing a hybrid motion sensing framework, comprising:
providing a motion capture framework worn by a user to measure a user posture and motion by measuring an external source signal and an inertial property of the motion capture framework, wherein the motion capture framework comprises a set of motion sensing units (MSUs) and an electromagnetic field generator (EFG), wherein the MSU is a hybrid sensing system using a combination of sensors to measure position and orientation and wherein the EFG generates an alternating electromagnetic field with a specified frequency;
calculating the user posture and motion based on the measuring an external source signal and an inertial property of the motion capture framework using a sensor fusion algorithm;
visualizing the position and orientation of the user.

2. The computerized process of claim 1, wherein the motion capture framework comprises a smart glove with both an internal and an external EFG.

3. The computerized process of claim 1, wherein the motion capture framework comprises the smart glove with the internal EFG.

4. The computerized process of claim 1, wherein the motion capture framework comprises a smart glove with the external EFG.

5. The computerized process of claim 2, wherein the motion capture framework comprises a three-axis accelerometer.

6. The computerized process of claim 5, wherein the motion capture framework comprises a three-axis Gyroscope.

7. The computerized process of claim 6, wherein the motion capture framework comprises a three-axis electromotive force (EMF) sensor.

8. The computerized process of claim 7, wherein the motion capture framework comprises a three-axis magnetometer.

9. The computerized process of claim 8, wherein the external source signal is used to obtain a high accuracy position and orientation measurement with respect to a fixed reference point.

10. The computerized process of claim 9, wherein when the motion capture framework is out of range of the external source signal, the motion capture framework utilizes a set of inertial measurements for estimating the relative position and orientation of the user.

11. The computerized process of claim 10, wherein when the motion capture framework is out of range of the external source signal, the motion capture framework utilizes a set of inertial measurements for estimating the relative position and orientation of the user with respect to a last known absolute position and orientation of the user.

12. The computerized process of claim 11, wherein the sensor fusion algorithm uses information from any available sensor in the motion capture framework.

13. The computerized process of claim 12, wherein the sensor fusion algorithm then fuses the sensor information to obtain an optimal estimate of the position and orientation of the user.

14. The computerized process of claim 13, wherein the visualizing of the position and orientation of the user comprises:
applying the position and orientation information of the motion capture framework to a specified model.

15. The computerized process of claim 14, wherein the specified model comprises a rigid body and a textured body to display an assembly of sensors.

16. The computerized process of claim 15, wherein the smart glove comprises smart glove mode of operation comprising a finger-only positioning mode.

17. The computerized process of claim 16, wherein in the finger-only positioning mode a three-axis EFG positioned on the back of the glove generates an EMF field.

18. The computerized process of claim 17, wherein the EMF field produces a voltage over the coils in each axis of the EMF-sensor, and wherein the voltage is used to calculate the position and orientation of the user with respect to the internal EFG.

19. The computerized process of claim 18, wherein the smart glove mode of operation comprises a global positioning mode.

20. The computerized process of claim 19, wherein in the global positioning mode an external three-axis EFG generates an electromagnetic (EMF) field.
